(19) United States
(12) Patent Application Publication
(10) Pub. No.: US 2020/0055260 A1
(43) Pub. Date: Feb. 20, 2020

(54) SEALING APPARATUS FOR FORMING VOID-FILL PACKAGING

(71) Applicant: GREEN LIGHT PACKAGING LIMITED, Cardiff (GB)

(72) Inventors: Mark Helmich, Usk (GB); Daniel Walmsley, Usk (GB); Jeremy Saunders, Usk (GB)

(21) Appl. No.: 16/610,387

(22) PCT Filed: May 4, 2018
(86) PCT No.: PCT/GB2018/051203

§ 371 Date: Nov. 1, 2019

(30) Foreign Application Priority Data
May 4, 2017 (GB) 1707130.9

(51) Int. Cl. B29C 65/00; B29C 65/30; B29C 65/78; B31D 5/00

(52) U.S. Cl. CPC B29C 66/43121; B29C 65/305; B29C 65/7894; B29C 66/004; B29C 66/73921; B29C 66/81419; B31D 5/0073; B29C 66/83413; B29C 66/8511; B29C 66/8762; B29C 66/91231; B29C 66/91421; B29C 66/9672; B29C 66/8227

(57) ABSTRACT

There is provided a sealing apparatus for forming void-fill packaging which includes a longitudinal guide path along which an edge of a part-sealed plastics film material can pass, a drive means for moving the film material along the guide path, and an air blowing or injecting means for inflating the film material. There is also provided a heating element and a rigid thermally conductive member which is thermally coupled to the heating element, the thermally conductive member having an film-contacting surface for applying thermal energy to seal the film material on the longitudinal guide path.

The present invention relates to a sealing apparatus, preferably but not necessarily exclusively for forming air-cushion type void-fill packaging. The invention also relates to a sealing system utilising such a sealing apparatus.

Void-fill material, such as air-cushion packaging is well-known for insertion into parcels to help protect the contents from shock and damage, and can be inserted into spaces or voids which exist between the contents and the sides of the parcel.

Such packages are typically formed from plastics film material which are inflated and sealed around their perimeter in order to enclose the air enveloped inside the material. This is performed by heat welding at least one edge of the plastics film material closed.

If the temperature of the welding process is too cool, then the package will not be adequately sealed, and the air will be expelled from the packaging. On the other hand, if the welding process is too hot, then the plastics film material will become too liquid, and a poor seal or no seal at all will be formed. Careful control of the weld temperature is therefore important to forming usable void-fill packages.

Traditionally, heater wires have been used as the sealing mechanism, which are low cost, but have a short working lifespan, and are difficult to control the temperature within necessary tolerances for long periods of time in order to obtain the optimum sealing conditions. Such wires typically require the use of polytetrafluorethylene (PTFE) belts around the heating and driving mechanisms in order to help with the passage of film through the sealing machine. These belts require regular changing as the PTFE wears, and results in significant proportions of non-operational time for the machine. The quality of the sealing process also varies as the PTFE belt and heater wires wear. A higher heating temperature of the wire is also required, again resulting in a higher rate of degredation, reduced longevity, and less accurate heating control.

Additionally, when a sealing apparatus is stopped, the heating of the plastics film material will continue, and therefore some plastics film material will be wasted if the machine must stop. This can be extremely inefficient.

The present invention seeks to provide a sealing apparatus which negates the need for wearable film-contacting components in order to extend the working life of the apparatus.

According to a first aspect of the invention, there is provided a sealing apparatus for forming void-fill packaging, the sealing apparatus comprising: a longitudinal guide path along which an edge of a part-sealed plastics film material can pass; drive means for moving the film material along the guide path; air blowing or injecting means for inflating the film material; a heating element; and a rigid thermally conductive member which is thermally coupled to the heating element, the thermally conductive member having a film-contacting surface which is positionable at the longitudinal guide path so as to contact the edge of the part-sealed plastics film material passed therealong.

The provision of a thermally conductive member which directly couples to the part-sealed plastics film material during the air injection process ensures that the less durable heating wire and PTFE tape or belt arrangement presently used can be dispensed with. The rigid thermally conductive member has a durable surface which will not wear over time, and therefore an even application of heat can be provided to the film material, ensuring consistent production of the seal. This provides more accurate control of the welding temperature over a longer duration, whilst also eliminating the need to replace the PTFE tape or belt, resulting in less maintenance time being required for the apparatus. This allows for the preparation of a more effective seal along an edge of the part-sealed plastics film material which was less likely to rupture during transportation.

Preferably, the heating element may comprise a mounting to which the thermally conductive member is mountable and a cartridge heater and/or thermocouple which is receivable within the mounting. Furthermore, the heating element may further comprise a temperature sensor receivable within the mounting.

The provision of a mounting which couples to the thermally conductive member provides for a useful means of providing a thermal pathway from the heating element to the integral film-contacting surface, whilst a temperature sensor enables the user to accurately determine the temperature of said surface, which may need to be altered depending upon the thickness of the film material used and/or a speed at which the material is being processed.

Optionally, the integral film-contacting surface may be formed as an elongate surface which extends along at least part of the longitudinal guide path.

The greater the extent of the integral film-contacting surface along the longitudinal guide path, the greater the likelihood of a smooth seal being formed along the full extent of the edge of the part-sealed plastics film material.

Preferably, two said heating elements may be provided in a spaced apart relationship about the longitudinal guide path.

The provision of spaced apart heating elements allows for the sealing of both sides of the edge of the part-sealed plastics film material simultaneously, therefore drastically improving the probability of a usable seal being formed and/or reducing sealing time.

Preferably, one of the said heating elements may be movable relative to the other said heating element, to permit widening of the longitudinal guide path.

The ability to widen the longitudinal guide path allows for more ready access to the heating elements, which is advantageous for loading of the part-sealed plastics film material, as well as for cleaning the heating elements should there be a blockage for any reason. Additionally, the separability of the heating elements also inhibits the sticking of the part-sealed plastics film to the thermally conductive members in the event of the sealing apparatus stopping. This has the added benefit of removing the contact between the thermally conductive members and the part-sealed plastics film in the stopped condition, the film being held in position by the drive wheels. When the sealing apparatus is restarted, the part-sealed plastics film can then just be reinserted in the same position, and this significantly reduces the wastage of material.

Preferably, the movable said heating element may be mounted to a movable plate, the other said heating element being mounted to a fixed plate, the movable plate being movable relative to the fixed plate.

Movable, and preferably slideable plates, provides a simple mechanism for ensuring that the alignment of the heating elements is not lost during the actuation process, and that the relative alignment is always maintained thereby ensuring the consistent separation along the full length of the thermally conductive members.

The apparatus may further comprise a driving mechanism for adjustably moving the movable plate relative to the fixed plate.

A driving mechanism, preferably in the form of a stepper motor, advantageously allows for precise control over the separation of the thermally conductive members, not only improving the ability to clean the heating elements, but also potentially providing some capability to seal part-sealed plastics film materials of differing thicknesses.

Additionally, or alternatively, the apparatus may further comprise a biasing means for biasing the movable plate relative to the fixed plate such that the heating elements are proximate to one another.

Biasing the movable plate to the sealing condition ensures that there is no prospect of the apparatus becoming jammed in an unusable configuration, maintaining a consistent seal for the packaging created.

The sealing apparatus may further comprise a heater assembly including a heater casing within which the heating element and thermally conductive member are contained, the integral film-contacting surface being positioned at or adjacent to an edge of the heater casing.

The heater casing acts to insulate the heating element from the remaining components within the housing, whilst the positioning of the integral film-contacting surface also allows an edge of the heater casing to act as a guide for the edge of the part-sealed plastics film material.

In one preferred embodiment, the thermally conductive member may have at least one curved or chamfered end.

By removing any sharp edges of the thermally conductive member, the possibility of tearing or damaging the void-fill packaging as it is being sealed is significantly reduced.

Preferably, the air blowing or injecting means may be positioned immediately prior to the heating element and thermally-conductive member on the longitudinal guide path. The drive means may also be positioned immediately following the heating element and thermally-conductive member on the longitudinal guide path.

The relative positioning of the components of the apparatus ensures that the filling of the air cushion with air is performed immediately before sealing, thereby minimising any loss of captured air in the intervening period. The positioning of the drive means also allows for a smooth and accurate drive of the part-sealed plastics material through the apparatus.

The sealing apparatus may optionally include a reel mounting element for mounting a reel of part-sealed plastics film material.

The provision of a reel mounting element allows the reel of the part-sealed plastics film material to be correctly positioned relative to the longitudinal guide path to ensure that the film material is correctly drawn through the apparatus so as to form a usable seal.

A temperature controller may preferably be associated with the heating element, in which case a wireless communication means may be associated with the temperature controller, the temperature controller automatically adjusting an output of the heating element based on a signal received by the wireless communication means. Said wireless communication means may be an RFID receiver.

The provision of a wireless communication means and temperature controller advantageously allows the apparatus to accept automatic remote control of the temperature of the film-contacting surfaces, which may be of particular use for arrangements in which different film thicknesses and/or processing speed, and therefore weld temperatures, are required.

In one preferable embodiment, the thermally conductive member may be formed from aluminium.

Aluminium provide good thermal conductivity, whilst being readily formable into the necessary shape required for the thermally conductive member.

Preferably, the integral film-contacting surface may be devoid of a friction-reducing coating. Alternatively, the integral film-contacting surface may comprise a friction-reducing coating.

Since the PTFE belt is one of the most likely components of existing sealing apparatuses to fail, it is very advantageous to provide an arrangement in which no such belt is necessary to protect the film material from a heated wire. The present invention as a result requires much less ongoing maintenance, and therefore has a greater operational lifespan than existing arrangements. However, some form of non-stick coating of the film-contacting surface may advantageously reduce the prospect of the plastics material sticking to the thermally conductive member during use.

According to a second aspect of the invention, there is provided a sealing system for forming void-fill packaging, the system comprising: a sealing apparatus and a reel of plastics film material having a manufacturing parameter identifier associated therewith, the sealing apparatus comprising: a guide path for the plastics film material to pass therealong; and heating means for providing a seal between layers of the plastics film moving along the guide path; the heating means including a receiver for wirelessly receiving a signal associated with the manufacturing parameter identifier and a temperature controller for automatically setting a temperature based on said signal. Preferably the receiver is an RFID receiver. Additionally, the manufacturing parameter identifier may be an RFID tag embedded in the reel of the plastics film material.

The system of the present invention allows for different reels to be provided for a given sealing apparatus, with film materials of different thicknesses which require different weld temperatures. The wireless communication between the manufacturing parameter identifier and the temperature controller advantageously eliminate the human interaction from the system, allowing for the temperature to be automatically adjusted in accordance with the requirements of the film. The temperature could also be adjusted in accordance with additional identifiers which may be relevant to the manufacturing process, such as the speed of throughput of the film, the length of the film, the packaging size, and so forth.

According to a third aspect of the invention, there is provided a sealing apparatus for forming void-fill packaging, the sealing apparatus comprising: a longitudinal guide path along which an edge of a part-sealed plastics film material can pass; drive means for moving the film material along the guide path; air blowing or injecting means for inflating the film material; a heating element; and a rigid thermally conductive member which is thermally coupled to the heating element, the thermally conductive member having a film-contacting surface for applying thermal energy to directly seal the film material on the longitudinal guide path.

The invention will now be more particularly described, by way of example only, with reference to the accompanying drawings, in which:

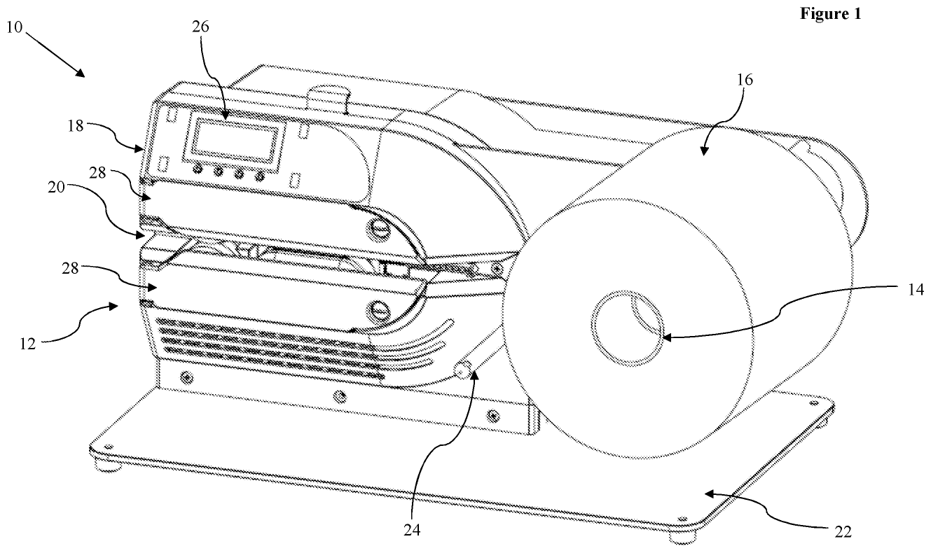

FIG. 1 shows a perspective representation of one embodiment of a sealing apparatus in accordance with the first aspect of the invention;

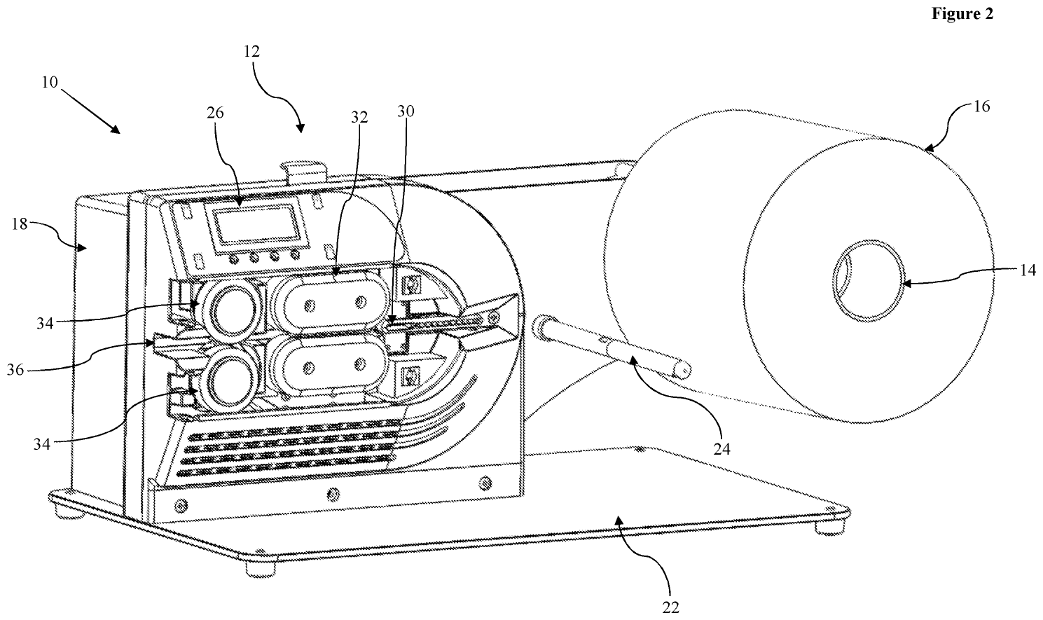

FIG. 2 shows a second perspective representation of the sealing apparatus of FIG. 1 with an access panel removed from the apparatus to reveal the longitudinal guide path;

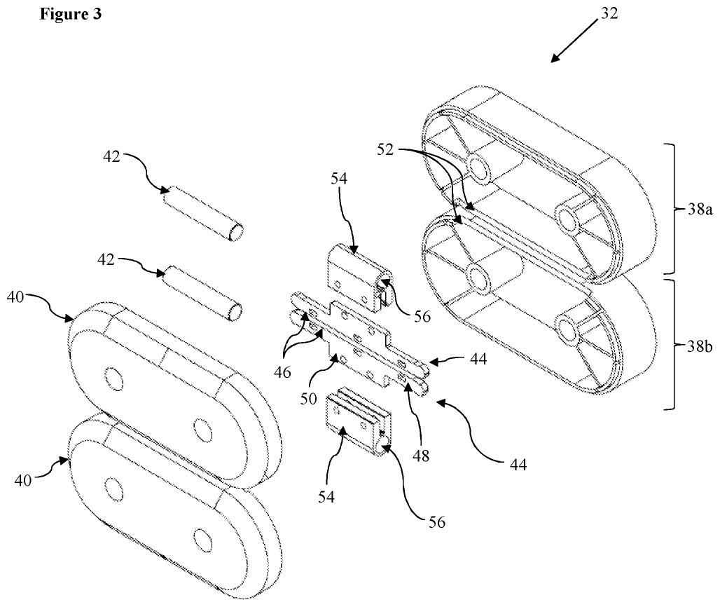

FIG. 3 shows an exploded perspective representation of the heater assembly of the sealing apparatus of FIGS. 1 and 2;

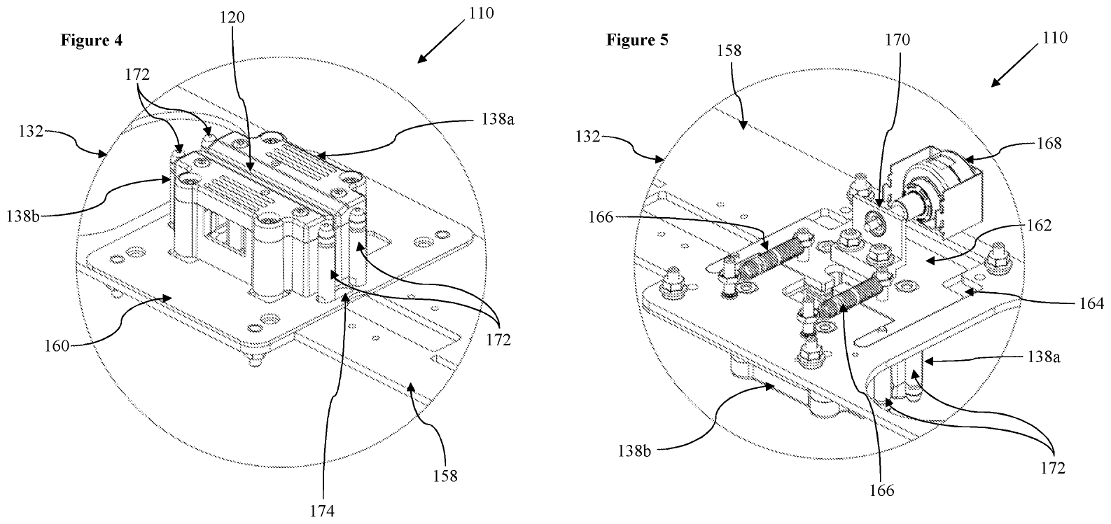

FIG. 4 shows a perspective representation from above of a second embodiment of a heater assembly for a sealing apparatus in accordance with the first aspect of the invention; and

FIG. 5 shows a perspective representation from below of the heater assembly of FIG. 4.

Referring to FIG. 1, there is illustrated a sealing apparatus, indicated globally at 10, for forming void-fill packaging from part-sealed plastics film material, typically being constructed as an air-cushion package.

A part-sealed plastics film material is here defined as a bi-layered plastics film which has been sealed along at least one edge thereof. Typically, the film will be pre-sealed along three edges of the perimeter of the void-fill packaging to be inflated, with a fourth and final edge to be sealed by the sealing apparatus 10. The bi-layer therefore defines a region in which air can be injected to form a void-filling cushioned package. The plastics material is typically biodegradable, compostable, recyclable or photodegradable film.

The sealing apparatus 10 comprises a housing 12 to which is mounted a reel mounting element 14 to which a reel 16 of part-sealed plastics film material can be mounted, and a housing body 18 within which the operational components of the sealing apparatus 10 are located. The housing body 18 includes a, preferably elongate, channel 20 running therethrough which defines a longitudinal guide path along which the part-sealed plastics film material can be fed to be sealed.

The housing 12 may optionally be provided having a stand 22, here formed as a base plate attached to the housing body 18, and is arranged to support the housing 12 such that the elongate channel 20 lies in an in-use horizontal plane.

There may also be provided a tensioning element 24 which is positioned on the housing 12 at or adjacent to the reel mounting element 14 to tension part-sealed plastics film material which is drawn from the reel 16 along the longitudinal guide path. A plurality of said tensioning elements may be provided, and may serve to tension the film, support different widths of film, and guide the film directly into the channel 20.

The housing body 18 may include a control panel 26 which acts as a user interface for the sealing apparatus 10, allowing a user to manually control at least an activation status of the sealing apparatus 10. The housing body 18 may also further comprise an access panel 28 which is removable to permit a user to interact with the operational components of the sealing apparatus 18 which are inside the housing body 18.

The sealing apparatus 10 is illustrated in FIG. 2 with the access panel 28 removed to show the operational components which are arranged on the longitudinal guide path. These components include an air injection means, here illustrated as an air blower or injector 30 positioned at or near the start of the longitudinal guide path within the elongate channel 20, though other forms of blower or air supplier could be provided. The air blower 30 is arranged to direct pressurised air from an air source into an open edge of the part-sealed plastics film material which has been directed through the elongate channel 20. In a preferred embodiment, the air blower 30 is formed by the use of a pressurised air source which directs air through an orifice at or substantially at right-angles to the direction of travel of the part-sealed plastics film material. An air injector may alternatively be formed as a hollow needle-like injector which is mounted within the elongate channel 20. An air conduit may be provided between the air blower 30 and an air supply device, such as a pump, which may supply air in a pressure range of 50 to 500 millibar, and preferably at or substantially at 200 millibar.

The air blower 30 may be provide with a separating member which is able to separate the layers of the part-sealed plastics film material in order for the air blower 30 to be able to inject air between the layers to form a cushion.

Following the air injection means is provided a heater assembly 32 which provides the necessary heating which will seal the edge of the part-sealed plastics film material to form a complete void-fill packaging.

Subsequent to the heater assembly 32 is provided a drive means, here formed as a pair of roller wheels 34 which are able to draw the part-sealed plastics film material along the longitudinal guide path and out of an open end 36 of the elongate channel 20. A cutter may also be provided which is able to separate adjacent void-fill packaging cushions, or a continuous chain of void-fill packaging cushions may be provided. The drive means does not necessarily need to be provided at the end of the longitudinal guide path, though this may improve the smoothness of the drive.

The roller wheels 34 may be provided with a gripping surface which can improve grip between the roller wheels 34 and the part-sealed plastics film material which is drawn along the longitudinal guide path, and an engagement may be improved by the provision of a friction-increasing coating on the said gripping surface. Other forms of driving means could be provided, such as a belt roller or motor arrangement.

The heater assembly 32 is shown in detail in FIG. 3. In the present embodiment, there are provided upper and lower heating units 38a, 38b which are in-use spaced apart from one another either side of the longitudinal guide path.

Each of the upper and lower heating units 38a, 38b is formed having a heater casing 40, preferably formed as a two-part casing for easy assembly, within which is inserted a heating element 42 and a rigid thermally conductive member 44 which is thermally coupled to the heating element 42. The thermally conductive member 44 has an integral film-contacting surface 46 for applying thermal energy to seal the film material on the longitudinal guide path. An edge of the heater casing 40 may preferably act as a guide surface along the longitudinal guide path, having a flat surface along which the part-sealed plastics film material can move.

Each thermally conductive member 44 is preferably formed from a single piece of metal, preferably aluminium, and includes an elongate body portion 48 which defines the film-contacting surface 46 and a connector 50. The film-contacting surface 46 is therefore preferably elongate so as to extend at least in part along the longitudinal guide surface in use.

To limit the danger of tearing or scratching the part-sealed plastics film material in-use, the elongate body portion 48 of the thermally conductive member 44 may be provided so as to have curved or chamfered ends, such that no sharp corners are provided which can contact with the part-sealed plastics film material as it is drawn along the longitudinal guide path. Additionally, the part-sealed plastics film material may include a friction-reducing coating, such as a PTFE coating, which may reduce the likelihood of the plastics material sticking to the thermally conductive member 44 in use. Such a friction-reducing coating may, however, be omitted.

Each heater casing 40 preferably includes an opening 52 through which the thermally conductive member 44 may at least in part extend, such that the integral film-contacting surface 46 can be positioned on the longitudinal guide surface within the elongate channel 20.

The heating element 42 is preferably provided as a cartridge heater and/or associated with a thermocouple, which can be mounted in thermal engagement with the thermally conductive member 44. To engage the heating element 42 with the thermally conductive member 44, a dedicated mounting 54 which is engagable with the connector 50 of the thermally conductive member 44. The mounting 54 and connector 50 may be interengaged via one or more pins or fasteners.

The mounting 54 may include a receiving aperture 56 within which the heating element 42 is receivably engagable, and is preferably formed from a thermally conductive material so as to allow for the heating element 42 to provided conductive heating to the thermally conductive member 44. A separate thermally conductive element may be provided however, if it would be useful for any reason to form the mounting 54 from a thermal insulator. The mounting 54 may also include a thermistor mount 58 for receiving a thermistor or similar temperature sensor to determine a temperature of the integral film-contacting surface 46 and therefore the welding temperature of the sealing apparatus 10.

In use, a reel 16 of part-sealed plastics film material can be provided for rotation on the reel mounting element 14, and a free end of the reel 16 can be drawn through the guide channel 20 such that the part-sealed plastics film material is engaged by the drive means. The reel 16 is mounted such that an unsealed edge to be sealed is facing the air blower 30 and will be drawn through the heater assembly 32.

Once the sealing apparatus 10 is activated, the heating elements 42 will be activated, which will heat the thermally conductive member 44, and therefore the integral film-contacting surface 46 thereof, to a desired welding temperature, which is which is positioned at the longitudinal guide path so as to contact the edge of the part-sealed plastics film material passed therealong. The air blower 30 is activated, and will blow air into the part-sealed plastics film material via the unsealed edge to inflate the material so as to form cushions. The cushions will be in-use inflated on the outside of the elongate channel 20, whilst the unsealed edge remains inside the elongate channel 20.

The drive means can then be activated, and as the part-sealed plastics film material is brought into contact with the integral film-contacting surfaces 46 of the heater assembly 32, a seal will be formed along the unsealed edge of the part-sealed plastics film material. A series of air-filled cushions will then be output from the end of the longitudinal guide path.

The welding temperature required by the part-sealed plastics film material may be dependent upon the thickness of the material used in order to arrive at an adequate seal. As such, the above-described invention may be adapted in order to provide a temperature controller associated with the heating element 42. This may allow for adjustment of the welding temperature dependent upon the film material used.

Furthermore, there may be provided a wireless communication means associated with the temperature controller. The temperature controller may be able to automatically adjust an output of the heating element 42 based on a signal received by the wireless communication means, which may preferably be an RFID receiver. Such an arrangement may eliminate the need for a manually input temperature via the control panel 26.

In this instance, it may therefore also be possible to provide a reel 16 of part-sealed plastics film material which includes a wireless emitter, such as an RFID tag, which is able to provide an identification signal, preferably a manufacturing parameter identifier, such as a film-thickness identifier, which can be received and processed by the temperature controller. The identification signal can identify, for example, a thickness of the part-sealed plastics film material, and therefore the temperature controller can automatically adjust the temperature of the heating element 42 based on the signal from the reel 16. This advantageously ensures that, regardless of the film material to be processed, the correct welding temperature will be applied. It will be apparent, however, that other manufacturing parameters could be encoded, such as the length of the roll, the packaging size, and/or the required speed of throughput of the film through the apparatus 10. In particular, a faster throughput speed will likely require a higher temperature to create an effective seal.

It may be possible to improve the present invention, and an improved version of the sealing apparatus is indicated in FIGS. 4 and 5, referenced globally at 110, and indicating the heater assembly 132 thereof in detail. Identical or similar features of the second embodiment of the heater assembly will be referred to using similar or identical reference numerals, and further detailed description is omitted for brevity.

The heater assembly 132 comprises upper and lower heating units 138a, 138b which are mounted to the housing of the sealing apparatus 110 via a mounting element, such as the mounting plate 158 as illustrated. One of the upper and lower heating units 138a, 138b, here being the lower heating unit 138b, is fixedly mounted to the mounting plate 158, preferably via a separate, preferably positionally adjustable, support plate 160.

The upper heating unit 138a is then mounted to a movable support, here formed as a movable plate 162 which is slidably engagable with an aperture 164 of the mounting plate 158, though could just as readily be slidably engagable with the support plate 160.

The aperture 164 is preferably shaped to have a complementary but elongated shape to that of the movable plate 162, thereby defining a sliding channel within which the movable plate 162 can be readily linearly actuated.

The movable plate 162 is engaged with the mounting and/or support plate 158, 160 via a biasing means, preferably formed as at least one spring element 166 which is arranged to urge the moveable plate 162 towards the mounting and/or support plate 158, 160, such that the upper and lower heating units 138a, 138b are in as close proximity as possible. The biased condition maintains the thermally conductive members 44 in a sealing condition, should the part-sealed plastics film material be drawn through the be drawn through the guide channel 120. A pair of spaced apart spring elements 166 are provided, thereby ensuring a consistent biasing effect across the width of the movable plate 162.

A drive mechanism, preferably provided as an electric motor, and more preferably as a stepper motor 168 which is controlled via accurate positional control software, is then also provided so as to be coupled to the movable plate 162. The coupling may, for instance, be formed as a screw-threaded mounting block 170, which allows for the transmission of the rotational motion generated by the motor 168 into linear actuation of the movable plate 162. A linearly actuatable motor could also be utilised to achieve the same result.

To assist with smooth actuation of the movable plate 162 relative to the mounting and/or support plate 158, 160, there may also be provided a plurality of alignment elements, such as the alignment pins 172 illustrated. Here, there are two alignment pins associated with the movable plate 162, which are aligned through linear runs 174 of the support plate 160. The corresponding fixed alignment pins 172, that is, those connected to the support plate 160, may abut or be positioned close to the edge of the upper heating unit 138a to ensure that it also moves in a linear fashion with the movable plate 162.

This improved heater assembly 132 allows for simpler insertion and removal of the part-sealed plastics film material. The motor 168 can be activated, using control software of an associated controller or processor, to pull the upper and lower heating units 138a, 138b apart. This is achieved by drawing the movable plate 162 along the aperture 164 to separate the 138a, 138b, effectively widening the guide channel 120. The part-sealed plastics film material can then be more readily inserted and/or removed to or from the guide channel 120.

To return the sealing apparatus 110 to a sealing condition, the motor 168 can be reversed, and the spring elements 166 draw the movable plate 162 in the opposite direction, bringing the upper and lower heating units 138a, 138b once again into close proximity with one another.

The ability of the sealing apparatus 110 to widen the guide channel 120 also improves the ability to clean the thermally conductive members 44, should there have been a build-up of re-solidified part-sealed plastics film material thereon during the manufacturing process, thereby causing a blockage.

Additionally, the sealing apparatus 110 can be stopped without needing to remove the part-sealed plastics film material. Preferably, the activation of a stop command of the sealing apparatus 110 will automatically result in activation of the motor 168, thereby opening the guide channel 120. Based on the positioning of the tensioning element for the reel of part-sealed plastics material, this can automatically space the part-sealed plastics material away from the thermally conductive members 44, so that heating is immediately ceased on stopping the sealing apparatus 110.

In such a scenario, stopping of the sealing apparatus 110 beneficially ensures that it can be restarted without needing to replace the part-sealed plastics material, and wastage is kept to a minimum since the heat is immediately withdrawn from the part-sealed plastics material. As such, the restarting of the sealing apparatus 110 can be achieved without changing the reel position of the part-sealed plastics material.

It will be appreciated that such automated wireless control of the apparatus is not limited to use in the context of a sealing apparatus for forming void-fill packaging. There are many forms of void-fill packaging which can be provided to fill a void in a package, for example, paper- or cardboard-based packaging, which must be processed, crushed, and/or cut to shape and size for filling voids.

It may therefore be possible to provide RFID control of a void-fill material packaging-forming apparatus in which a processing means, which could be the temperature controller of the above-described embodiment, but could just as easily be a cutter, crusher, folder, or adhesive-based sealing means, is automatically adjustable or controllable based on a signal received from an external RFID element. This could, for example, be an RFID tag associated with the void-fill material to be processed, such as a reel of film or unprocessed paper or cardboard, or could be a dedicated RFID element which may be used to meter a specific amount of void-fill packaging material which is suitable for filling a particular void. In this scenario, a plurality of different RFID elements may be provided which each provide different control or adjustment signals for a processing controller of the void-fill material packaging apparatus.

For a general sealing apparatus, it may be possible to provide a sealing system for forming void-fill packaging, the system comprising a sealing apparatus and a reel of plastics film material having a manufacturing parameter identifier associated therewith. The sealing apparatus need only have a guide path for plastics film material to pass therealong, and heating means for providing a seal between layers of the plastics film moving along the guide path. Provided that the heating means includes a receiver for wirelessly receiving a signal associated with the manufacturing parameter identifier and a temperature controller for automatically setting a temperature based on said signal, which is preferably an RFID signal, then automatic temperature adjustment can be conducted based on the film thickness of the plastics film material. In particular, there could be an arrangement in which there is provided a thermocouple in communication with both the heating element, such as a cartridge heater, and the temperature controller, so as to permit the automatic temperature adjustment based on the detection of the wireless signal.

Whilst the above embodiment of the invention has been described in relation to a pair of heater assemblies which can seal a part-sealed plastics film material from either side of the longitudinal guide path, it may be possible to seal the film material from only one direction. In such an arrangement, it may be possible to utilise only a single heating assembly, which applies sufficient thermal energy from a single direction to create a suitable weld.

Furthermore, the or each said heater assembly may be utilised to seal plastics film or other material suitable for void-fill packaging along all or part of any dimensional extent, whether longitudinal, lateral or at angles thereto. As such, it is both unsealed plastics film material and part-sealed plastics film material could be sealed by the apparatus of the present invention.

It is therefore possible to provide a sealing apparatus for sealing the edge of part-sealed plastics film material to be formed into void-fill packaging solutions, which dramatically reduces the maintenance requirements for the apparatus, as the PTFE belts are no longer necessary components. Furthermore, an improved seal can be provided, thereby reducing the likelihood of failure of the void-fill packages once assembled.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A sealing apparatus for forming to form void-fill packaging, the sealing apparatus comprising:
a longitudinal guide path along which an edge of a part-sealed plastics film material can pass;
drive mechanism to move the film material along the guide path;
air blower or injector to inflate the film material;
a heating element; and
a rigid thermally conductive member which is thermally coupled to the heating element, the thermally conductive member having a film-contacting surface which is positioned at the longitudinal guide path so as to contact the edge of the part-sealed plastics film material passed therealong.

2. The sealing apparatus as claimed in claim 1, wherein the heating element comprises a mounting to which the thermally conductive member mounts, and a cartridge heater and/or thermocouple which is received within the mounting.

3. The sealing apparatus as claimed in claim 2, wherein the heating element further comprises a temperature sensor received within the mounting.

4. The sealing apparatus as claimed in claim 1, wherein the integral film-contacting surface is formed as an elongate surface which extends along at least part of the longitudinal guide path.

5. The sealing apparatus as claimed in claim 1, wherein two said heating elements are provided in a spaced apart relationship about the longitudinal guide path.

6. The sealing apparatus as claimed in claim 5, wherein one of the said heating elements moves relative to the other said heating element, to permit widening of the longitudinal guide path.

7. The sealing apparatus as claimed in claim 6, wherein the movable said heating element is mounted to a movable plate, the other said heating element being mounted to a fixed plate, the movable plate moves relative to the fixed plate.

8. The sealing apparatus as claimed in claim 7, further comprising at least one of: a driving mechanism to adjustably move the movable plate relative to the fixed plate; a biasing mechanism for biasing the movable plate relative to the fixed plate such that the heating elements are proximate to one another; and a reel mounting element to mount a reel of part-sealed plastics film material.

9. (canceled)

10. The sealing apparatus as claimed in claim 1, further comprising a heater assembly including a heater casing within which the heating element and thermally conductive member are contained, the integral film-contacting surface being positioned at or adjacent to an edge of the heater casing.

11. The sealing apparatus as claimed in claim 1, wherein the thermally conductive member has at least one curved or chamfered end.

12. The sealing apparatus as claimed in claim 1, wherein the air blower or injector is positioned immediately prior to the heating element and thermally-conductive member on the longitudinal guide path.

13. The sealing apparatus as claimed in claim 1, wherein the drive mechanism is positioned immediately following the heating element and thermally-conductive member on the longitudinal guide path.

14. (canceled)

15. The sealing apparatus as claimed in claim 1, further comprising a temperature controller associated with the heating element (42).

16. The sealing apparatus as claimed in claim 15, further comprising a wireless communicator associated with the temperature controller, the temperature controller automatically adjusting an output of the heating element based on a signal received by the wireless communicator.

17. The sealing apparatus as claimed in claim 16, wherein the wireless communicator is an RFID receiver.

18. The sealing apparatus as claimed in claim 1, wherein the thermally conductive member is formed from aluminium.

19. (canceled)

20. The sealing apparatus as claimed in claim 1, wherein the integral film-contacting surface comprises a friction-reducing coating.

21. A sealing system to form void-fill packaging, the system comprising:
a sealing apparatus; and
a reel of plastics film material having a manufacturing parameter identifier associated therewith;
the sealing apparatus comprising:
a guide path along which the plastics film material passes; and
heating mechanism to provide a seal between layers of the plastics film moving along the guide path;
the heating mechanism including a receiver to wirelessly receive a signal associated with the manufacturing parameter identifier and a temperature controller to automatically set a temperature based on said signal.

22. The sealing system as claimed in claim 21, further comprising at least one of: the receiver being an RFID receive; and the manufacturing parameter identifier being an RFID tag embedded in the reel of the plastics film material.

23. (canceled)

24. A sealing apparatus to form void-fill packaging, the sealing apparatus comprising:
a longitudinal guide path along which an edge of a part-sealed plastics film material can pass;
drive mechanism to move the film material along the guide path;
air blower or injector to inflate the film material;
a heating element; and
a rigid thermally conductive member which is thermally coupled to the heating element, the thermally conductive member having a film-contacting surface to apply thermal energy to directly seal the film material on the longitudinal guide path.
